(19) United States
(12) Patent Application Publication
(10) Pub. No.: US 2004/0199672 A1
(43) Pub. Date: Oct. 7, 2004

(54) System and method for high speed handshaking

(76) Inventor: Hsilin Huang, Milpitas, CA (US)

Correspondence Address: DECHERT LLP, P.O. BOX 10004, PALO ALTO, CA, 94303, US

(21) Appl. No.: 10/407,573

(22) Filed: Apr. 4, 2003

(51) Int. Cl. G06F 3/00

(52) U.S. Cl. 710/1

(57) ABSTRACT

A system for enabling communications between a first circuit block and a second circuit block of a processing system is described. The system has a plurality of registers for storing data from the first block. A steering circuit enables data to be written to one of the plurality of registers depending on the value of a write pointer signal. The data is only written to one the registers selected by the write pointer signal if that register is empty. The system also has a multiplexer to read the data from one of the plurality of registers in response to a read pointer signal. The data is only read from one of the registers selected by the read pointer signal if that register is full. The write and read pointers are each advanced so as to select the register to be written or read in a circular fashion.

### FIELD OF THE INVENTION

The present invention generally relates to communications in a processor, such as a graphics processor, and more particularly to a system and method of performing communications between logic blocks in the processor at high speeds.

### DESCRIPTION OF THE RELATED ART

As the speed of graphics engines increases from about 200 MHz to above 200 MHz, the need for more efficient communication between logic blocks has become more important. Referring to FIG. 1, typically two logic blocks in a graphics processor would communicate using simple AVL and ACK signaling. Specifically, if block 0 wanted to know if block 1 was available, then block 0 would send an AVL signal and wait for an ACK response to indicate that block 1 was ready. The ACK signal was generated by logically ‘ANDing’ the AVL signal with the results of the engine availability logic 14.

However, there is a delay associated with the receipt of the ACK signal. The delay is equal to:

ACK_{delay}=AVL_{delay}+wire delay_{(block 0 to block 1)}+logic delay of engine availability logic+wire delay_{(block 1 to block 0)}

Accordingly, the delays in the AVL signal logic and the engine availability logic, as well as the wire delays between block 0 and block 1 add up to the total delay in the system. Therefore, the timing delay for the ACK signal (i.e., ACK_{delay}) may cause the whole system to slow down operations.

Referring to FIG. 2, the situation is made worse when other blocks are cascaded together. For instance, in FIG. 2, block 0 is accessing block 1 which in turn is accessing block 2. The total delay to process the ACK signal is:

ACK_{delay}=AVL_{delay}+wire delay_{(block 0 to block 1)}+logic delay of engine availability logic block 1+wire delay_{(block 1 to block 2)+logic delay of engine availability logic block 2+wire delay}_{(block 2 to block 1)}+wire delay_{(block 1 to block 0)}

Therefore, it can be seen that, as multiple blocks are cascaded, the timing delay is made worse.

It is possible to add a register between the two blocks in order to decrease the timing delay. Specifically, referring to FIG. 3, block 1 includes a register 16 for storing data and the AVL status. The data and the AVL signal are clocked into the register 16 using the CLK signal. Block 1 further includes additional logic 18 for determining whether the AVL signal is present and the engine availability logic 14 is ready. By storing the data and AVL signal in the register 16, it is possible to increase speed of the system by avoiding the wire delays. Yet, by only using one register 16, data can only be clocked into the system after processing of the ACK signal. Furthermore, if there is a long timing delay in the engine availability logic 14, then there can still be a delay between block 0 and block 1.

Therefore, there is a need for a system and method which efficiently generates a handshaking signal between logic blocks, such as those in a graphics processor.

### BRIEF SUMMARY OF THE INVENTION

A method, in accordance with the present invention, includes a method of transferring data between clocked logic blocks. If a first condition is true, the first condition being that data is available from a first logic block and one of a plurality of registers is empty and selected by a write pointer signal, then the empty register selected by the write pointer signal is written to and the write pointer signal is advanced to a next register in circular order. If a second condition is true, the second condition being that a second logic block is capable of accepting data and one of the plurality of registers is full and selected by a read pointer signal, then the full register selected by the read pointer signal is read from and the read pointer signal is advanced to a next register in circular order. In one embodiment, there are two registers, the write and read pointers are each one bit and the write and read pointers are advanced by toggling the respective bits.

A system, in accordance with the present invention, for transferring data between clocked logic blocks includes a first logic block, a plurality of data registers, a steering circuit, a plurality of binary status flags, a second logic block, a multiplexer, and a handshake control circuit. The first logic block receives a clock signal and generates a block available signal when data is available to be transferred from the first logic block on the clock signal. The plurality of data registers are each configured to hold data received from the first logic block. The steering circuit is configured to couple the data from the first logic block to one of the plurality of data registers based on a write pointer signal. The plurality of binary status flags, where each flag is associated with one of the plurality of data registers, and are configured to indicate whether the associated one of the plurality of data registers is full with first logic block data. The second logic block receives the clock signal and generates an engine available signal when data is available to be accepted by the second logic block on the clock signal. The multiplexer is configured to couple the data from one of the plurality of data registers to the second logic block based on a read pointer signal, and the handshake control circuit receives the clock signal, the block available signal, and the engine available signal, the plurality of status flags and generates the read pointer and the write pointer signals, where the read pointer signal has a value derived from a first condition signal which is a function of the block available signal, the read pointer signal and the plurality of status flags, and the write pointer signal has a value derived from a second condition signal which is a function of the engine available signal, the write pointer signal and the plurality of status flags. In one embodiment, there are two registers, and two binary status flags.

One advantage of the present invention is that data can be transferred between clocked logic blocks quickly and efficiently, with minimum delay when the blocks are available to be transferred or accepted, but waits if the blocks are not available to be transferred or accepted.

Another advantage is that waiting for blocks to be available for transfer or acceptance does not adversely impact the speed of the transfer when the blocks are available.

### BRIEF DESCRIPTION OF THE DRAWINGS

These as well as other features of the present invention will become more apparent upon reference to the drawings wherein:

FIGS. 1-3 are block diagrams illustrating prior art communications in graphic processors; and

FIG. 4 is a system having blocks between which communications in accordance with the present invention are implemented;

FIG. 5 is a timing diagram illustrating the handshake operation;

FIG. 6 is an embodiment of a portion of the handshaking circuitry;

FIG. 7 shows an embodiment, in accordance with the present invention, in which three registers are used to transfer data between blocks;

FIG. 8A shows a state machine for advancing a multi-bit write pointer signal; and

FIG. 8B shows a state machine for advancing a multi-bit read pointer signal.

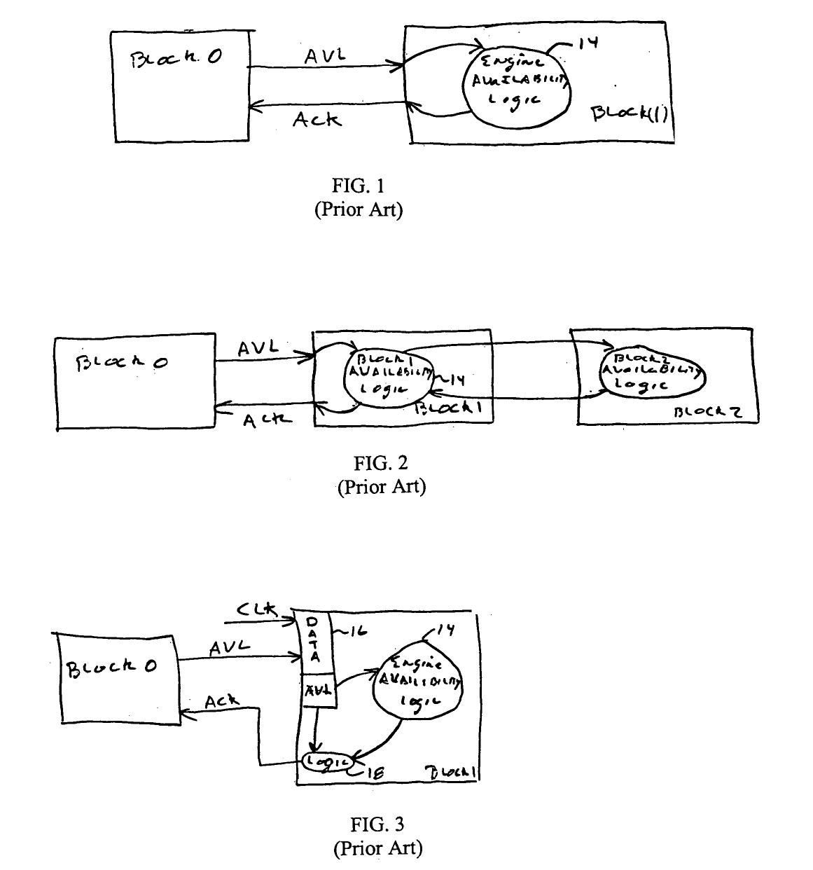

### DETAILED DESCRIPTION OF THE INVENTION

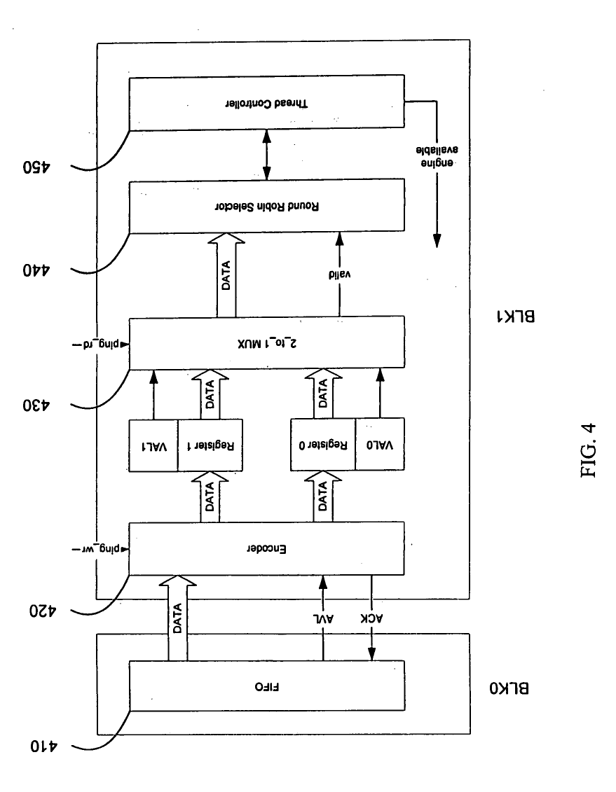

FIG. 4 shows an embodiment of a transfer logic system in which data is transferred from block 0 (BLK0) to block 1 (BLK1), in accordance with the present invention. A FIFO 410 provides the BLK0 data. The FIFO block 410 provides an AVL signal and receives an ACK signal. Steering logic (i.e., encoder) 420 receives a ping_wr signal to select either register 0 or register 1 for writing. Associated with register 0 is val0 and with register 1 is val1, which are used to indicate whether the respective registers contain new (un-transferred) BLK0 data. The outputs of register 0, register 1, and the flags val0 and val1 are sent to a 2:1 multiplexer 430 which is controlled by a ping_rd signal, to select one of the registers. The encoder, registers, multiplexer, round robin selector 440 and thread controller 450 act as BLK1.

In FIG. 4, the ACK signal indicates whether there is room in one of the registers to accept an entry, the ping_wr signal for pointing to either register 0 or register 1 for writing, a status signal val0 that indicates when register 0 is empty, val1 that indicates when register 1 is empty, and the ping_rd signal that points to register 0 or register 1 for reading. The Boolean equation for the ACK signal is

ACK=(˜ping_{—}wr & ˜val0)+(ping_{—}wr & ˜val1).

An advantage of the present invention is that the time delay for BLK0 to receive the ACK signal is short, the delay being the logic delay of ((˜ping_wr & —val0)+(ping_wr & ˜val1))+(wire delay from BLK1 to BLK0). This permits the system to operate at very high frequencies. For example, if the logic delay plus wiring delay is 1 nanoseconds, then the system can operate at about 1 GHz.

The conditions for writing register 0 are that ping_wr is 0 and val0 is 0 and data is available (AVL is true). This indicates that register 0 is the target register for the write and that the register is empty. The conditions for writing register 1 are that ping_wr is 1 and val1 is 0 and data is available (AVL is true). This indicates that register 1 is the target register for the write and that the register is empty. These two conditions are joined and ‘AND’ed with the AVL signal to form a cs_ping_wr signal,

cs_{—}ping_{—}wr=((˜ping_{—}wr & ˜val0)+(ping_{—}wr & ˜val1)) & AVL.

The conditions for reading register 0 are that ping_rd is 0 and val0 is 1. This indicates that register 0 is the target register for the read and that the register is full. The conditions for reading register 1 are that ping_rd is 1 and val1 is 1 indicating that register 1 is the target register for the read and that the register is full. These two conditions are joined and ‘AND’ed with an engine_available signal (which indicates when the engine is available) to form a cs_ping_rd signal,

cs_{—}ping_{—}rd=((ping_{—}rd & val0)+(ping_{—}rd & val1)) & (engine_{—}available).

Other helpful, related signals are ping_read_data_avl,

ping_{—}read_{—}data_{—}avl=((˜ping_{—}rd & val0)+(ping_{—}rd & val1)), and R_{—}ACK_{—}BLK0=BLK0_{—}AVL & BLK1_{—}ACK.

The first of these signals indicates the availability of read data, without regard to the engine availability logic, and the second indicates that BLK0 has data and has received an acknowledge from BLK1.

Generating the ping_rd and ping_wr signals must be done with minimum delay to improve the performance of the handshaking operation. The ping wr signal is initially set to zero, pointing to register 0. When a write occurs to register 0, causing register 0 to be full, then ping_wr must change to a 1 to point to register 1. When register 1 is written, causing register 1 to be full, then ping_wr must change to a 0. If neither register can be written, because both are already full, then ping_wr must not change state. These conditions are summarized by the following equation,

ping_{—wr}:=ping_wr ⊕ cs_ping_wr,

where cs_ping_wr=AVL & ACK, the symbol ⊕ indicates the XOR operation, and the symbol :=indicates that ping_wr changes on the clock edge. Similarly the equation for ping_rd is

ping_rd:=ping_rd ⊕ cs_ping_rd.

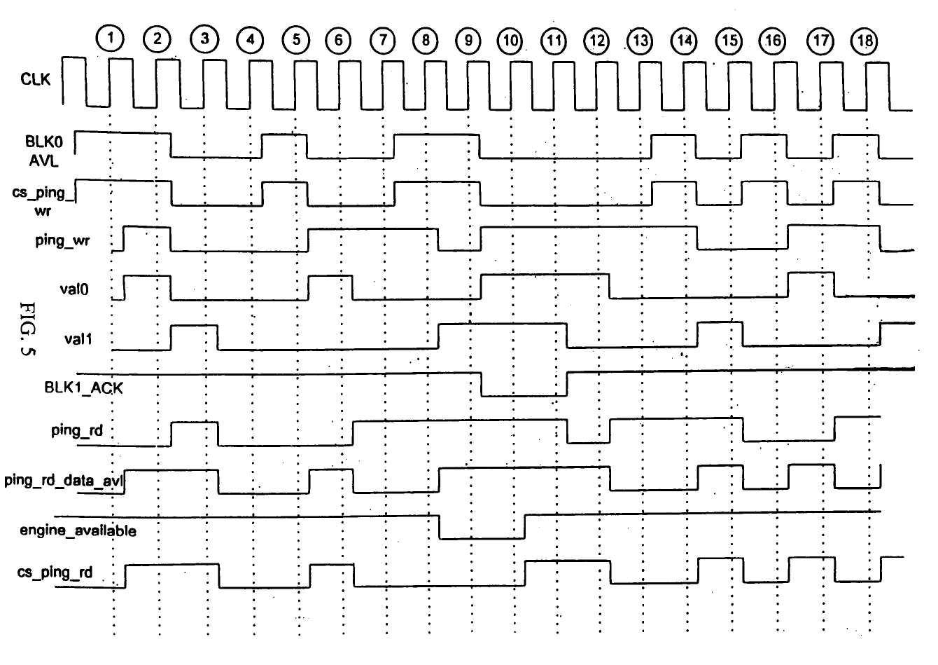

Referring now to FIG. 5, the timing diagram, and assuming initially that both register 0 and register 1 are empty (val0=0 and val1=0) and a block is available (BLK0_AVL=1), then cs_ping_wr is a 1. This signal, cs_ping_wr, can be considered a “control input” to the XOR gate, such that when cs_ping_wr is a 0, the ping_wr signal passes through the gate unchanged, but when cs_ping_wr is a 1, the ping_wr signal is inverted. Thus, if ping_wr is 0, pointing to register 0, then register 0 is written on the next clock edge, clock edge 1. On this same edge, val0 becomes 1, and ping_wr is inverted to become 1.

If data from BLK0 is still available, now register 1 can be written. On clock edge 2, register 1 is written with data, and because cs_ping_wr is 1, ping wr is inverted again, via the XOR gate, to become 0. At this point both registers are full, causing cs_ping_wr to become zero on clock edge 2, which holds the ping_wr signal in its current state, pointing to register 0.

When, in the above operations, on clock edge 1, register 0 is written and val0 becomes 1, the signal cs_ping_rd becomes true. Assuming that ping_rd is 0, pointing to register 0, conditions are present to read register 0 on clock edge 2. This occurs, thus emptying register 0, setting val0 to 0, and ping_rd to 1 so that it points to register 1. Because register 1 is full, val1 is 1, and cs_ping_rd is still true, register 1 is read on clock edge 3, which causes ping_rd to become 0, and cs_ping_rd to become 0.

Continuing with the timing diagram, on clock edge 4 data from BLK0 becomes available and cs_ping_wr becomes 1. The signal ping_wr is pointing to register 0, which is empty.

On clock edge 5, register 0 is written with the BLK0 data, cs_ping_wr becomes 0, and ping_wr becomes 1, pointing to register 1. With cs_ping_wr at a 0, the ping_wr signal is held at 1, awaiting data to become available.

On clock edge 6, the data is read from register 0, and val0 becomes 0. The signal ping_rd now points to register 1 and the read logic waits for register 1 to become full.

On clock edge 7, data becomes available, and on clock 8, is entered into register1. Clock edge 8 also causes, the ping_wr signal to become 0, and val1 to become 1. Thus, data is now available to be read, but the engine_available signal is 0, indicating that the read logic is not able to take the data. This is indicated by ping_read_data_avl being 1, but cs_ping_rd being 0.

On clock edge 9, because data is available from BLK0, and register 0 is empty, data is written into register 0 and val0 becomes 1. At this point both registers are full.

On clock edge 10, the engine_available signal becomes 1, indicating that the data can be taken by the read logic. On this edge, cs_ping_rd becomes 1 as well. The signal ping_rd has maintained its state pointing to register 1 while the engine_available signal was 0, because cs_ping_rd was 0.

On clock edge 11, the data is read from register 1, causing val1 to become 0, and ping_rd to become 0.

On clock edge 12, data is read from register 0, causing val0 to become 0, and ping_rd to become 1. Now both registers are empty.

On clock edge 13, new data becomes available from BLK0 and cs_ping_wr becomes 1.

On clock edge 14, the new data is entered into register 1, because ping_wr has been kept at a 1, after having written register 0 on clock edge 9. Also on this edge, val1 becomes 1, ping_read_data_avl and cs_ping_rd both become 1 and ping_wr becomes 0.

On clock edge 15, data is read from register 1, val1 becomes 0, ping_rd becomes 0, pointing to register 0, and both ping read data_avl and cs_ping_rd become 0. At this point both registers are empty. Also, on this edge, data becomes available from BLK 0.

On clock edge 16, data is entered into register 0, val0 becomes 1, ping_wr becomes 1, and both cs_ping_rd and ping_read_data_avl become 1.

On clock edge 17, data is read from register 0, val0 become 0, both ping read_data_avl and cs_ping_rd become 0, and ping_rd becomes 1. Also, on clock edge 17, data becomes available from BLK0.

On clock edge 18, data is entered into register 1, val1 becomes 1, and both cs_ping_rd and ping_read_data_avl become 1. Data is read on the next edge.

In summary, the shortest time from data being available in a register to the time it is read is one clock period. However, the logic gracefully handles the case when data is not available or data cannot be taken by the read logic without upsetting the best case timing.

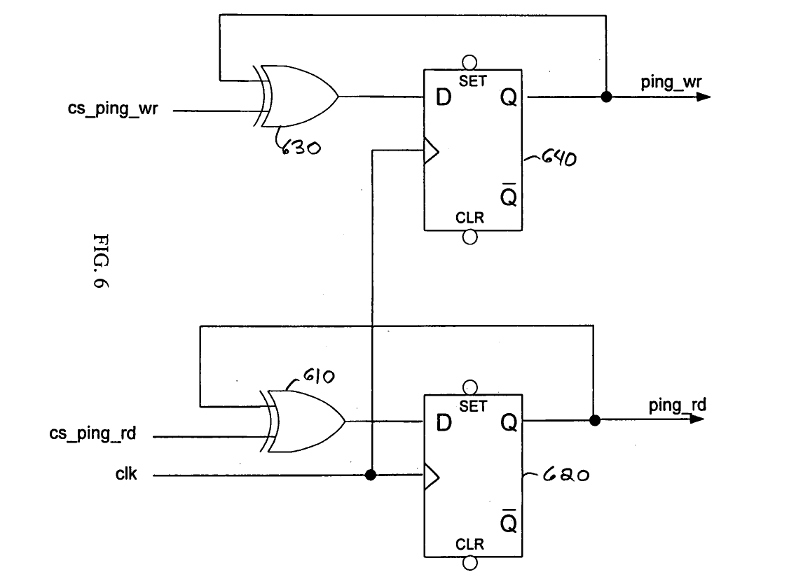

In one embodiment the ping_wr signal and ping_rd signal are each derived from a flip-flop (here, as a simple illustration, a D-type flip-flop is used) and an XOR gate, as show in FIG. 6. For the ping_rd signal, the XOR gate 610 receives the Q-output of the D flip-flop 620 and the cs_ping_rd signal. The output of the XOR gate 610 is connected to the D input of the flip-flop 620, which is clocked by the system clock, clk. For the ping_wr signal, the XOR gate 630 receives the Q-output of the D flip-flop 640 and the cs_ping_wr signal. The output of the XOR gate 630 is connected to the D input of the flip-flop 640 which is clocked by the system clock, clk.

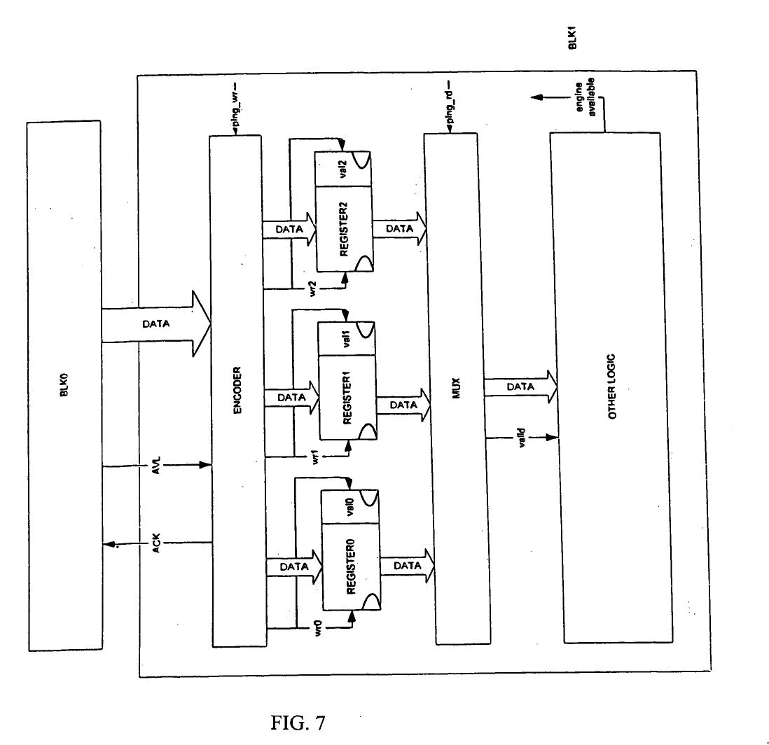

Although the present invention has been described in considerable detail with reference to certain preferred versions thereof, other versions are possible. For example, another version shown in FIG. 7, employs three registers, register 0, register 1 and register 2, and three valid bits, val0, val1, and val2, in the transfer of data between BLK0 and BLK1. The registers are selected by the ping_wr signal, which is now a signal having two bits. The encoder in FIG. 7 decodes the ping_wr signal to generate the wr0, wr1 and wr2 signals, which select the respective registers, register 0, register1, and register 2. In one alternative, the ping_wr signal has states b'00, b'01, and b'10, state b'00 decoded to select register 0, state b'01 decoded to select register 1 and state b'10 decoded to select register 2, thus adhering to selecting the registers in circular order. In another alternative, Grey codes can be used to minimize the decoding.

The multiplexer in FIG. 7 receives the ping_rd signal which is now also two bits. The different states of the ping_rd signal are decoded in the multiplexer to select one of the registers. In this version, the ping_rd signal is a two bit signal, which has values b'00, b'01 and b'10. When ping_rd is b'00, the first register is selected, when ping rd is b'01, the second register is selected and when ping_rd is b'10, the third register is selected, thus adhering to selecting the registers in circular order. Again, Grey coding can be used to minimized the amount of decoding needed.

The ping_wr signal changes state when the cs_ping_wr signal is true and a clock edge occurs, according to the following algorithm,

{if(RESET)

ping_wr = ‘00’

else if(cs_ping_wr & ping_wr = = ‘00’)

ping_wr = ‘01’

else if(cs_ping_wr & ping_wr = = ‘01’)

ping_wr = ‘10’

else if(cs_ping_wr & ping_wr = = ‘10’)

ping_wr = ‘00’

}

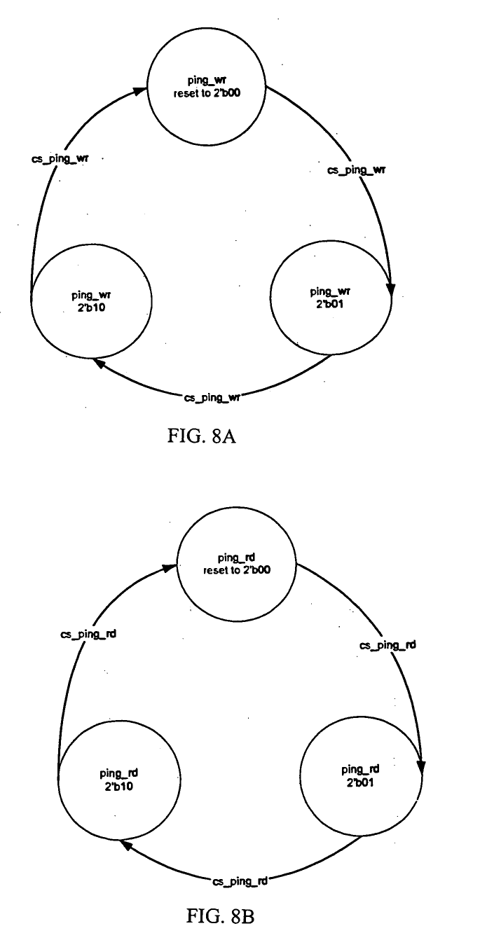

This is illustrated as a state machine for ping_wr in FIG. 8A. Also, the cs_ping_wr=(((ping_wr==b'00‘) & ˜val0)+((ping_wr==b'01') & ˜val1)+((ping_wr==b'10') & ˜val2)) & AVL

The ping_rd signal is implemented in a similar fashion and is shown in the state machine in FIG. 8B. The cs_ping_rd signal is (((ping_rd==b'00') & val0)+((ping_rd==b'01') & val1)+((ping_rd==b'10') & val2)) & (engine_available). Similar adjustments are made to the other signals. Thus, one of skill in the art can see that the present invention is extensible to any number of registers with the appropriate adjustments. Therefore, the spirit and scope of the appended claims should not be limited to the description of the preferred versions contained herein.

What is claimed is:

1. A method of transferring data between clocked logic blocks, comprising:
if a first condition is true, the first condition being that data is available from a first logic block and one of a plurality of registers is empty and selected by a write pointer signal,
writing to the empty register selected by the write pointer signal; and
advancing the write pointer signal to a next register in circular order; and
if a second condition is true, the second condition being that a second logic block is capable of accepting data and one of the plurality of registers is full and selected by a read pointer signal,
reading from the full register selected by the read pointer signal; and
advancing the read pointer signal to a next register in circular order.

2. A method of transferring data as recited in claim 1,
wherein there are two registers in the plurality of registers and the read pointer signal and the write pointer signal are each a single bit; and
wherein the step of advancing the write pointer signal to a next register in circular order includes toggling the write pointer signal to the register not selected for writing and the step of advancing the read pointer signal to a next register in circular order includes toggling the read pointer signal to the register not selected for reading.

3. A method of transferring data as recited in claim 2, wherein toggling the write pointer signal is performed by forming a result signal that is the XOR of the write pointer signal and the first condition and clocking the result with a clock signal.

4. A method of transferring data as recited in claim 2, wherein toggling the read pointer signal is performed by forming a result signal that is the XOR of the read pointer signal and the second condition and clocking the result with a clock signal.

5. A system for transferring data between clocked logic blocks, comprising:
a first logic block that receives a clock signal and generates a block available signal when data is available to be transferred from the first logic block on the clock signal;
a plurality of data registers, each for holding data received from the first logic block;
a steering circuit for coupling the data from the first logic block to one of the plurality of data registers based on a write pointer signal;
a plurality of binary status flags, each flag associated with one of the plurality of data registers, and for indicating whether the associated one of the plurality of data registers is full with first logic block data;
a second logic block that receives the clock signal and generates an engine available signal when data is available to be accepted by the second logic block on the clock signal;
a multiplexer for coupling the data from one of the plurality of data registers to the second logic block based on a read pointer signal; and
a handshake control circuit that receives the clock signal, the block available signal, and the engine available signal, the plurality of status flags and generates the read pointer and the write pointer signals, the read pointer signal having a value derived from a first condition signal which is a function of the block available signal, the read pointer signal and the plurality of status flags, and the write pointer signal having a value derived from a second condition signal which is a function of the engine available signal, the write pointer signal and the plurality of status flags.

6. A system as recited in claim 5,
wherein the first condition is true when the block available is true and one of the plurality of data registers is not full and said data register is selected by the write pointer signal; and
wherein the second condition is that engine available is true and one of the plurality of data registers is full and said data register is selected by the read pointer signal.

7. A system as recited in claim 6, wherein the read pointer and write pointer signals each include a sufficient number of bits to select any of the registers in the plurality of registers.

8. A system as recited in claim 5,
wherein there are two registers in the plurality of registers and the read pointer signal and write pointer signal are each a single bit;
wherein the first condition is true when the block available signal is true and either the first data register is not full and selected by the write pointer signal or the second data register is not full and selected by the write pointer signal; and
wherein the second condition is true when the engine available is true and either the first data register is full and selected by the read pointer signal or the second data register is full and selected by the read pointer signal.

9. A system as recited in claim 8, further comprising:
a first XOR gate that receives the first condition signal and the write pointer signal, and
a first flip-flop having an input that receives the output of the first XOR gate, a clock input that receives the clock signal, and an output that generates the write pointer signal when the clock signal changes;
a second XOR gate that receives the second condition signal and the write pointer signal, and
a second flip-flop having an input that receives the output of the second XOR gate, a clock input that receives the clock signal and an output that generates the write pointer signal when the clock signal changes.

10. A system as recited in claim 9, wherein the flip-flops are D-type flip-flops.
